(19) United States
(12) Patent Application Publication
(10) Pub. No.: US 2024/0147887 A1
(43) Pub. Date: May 9, 2024

(54) JOINT ASSEMBLY FOR AN AGRICULTURAL IMPLEMENT

(71) Applicant: CNH Industrial America LLC, New Holland, PA (US)

(72) Inventor: Brittany Ann Schroeder, Bunker Hill, IN (US)

(21) Appl. No.: 17/980,385

(22) Filed: Nov. 3, 2022

(51) Int. Cl. A01B 63/22; A01B 76/00; A01B 79/00

(52) U.S. Cl. CPC A01B 63/22; A01B 76/00; A01B 79/005

(57) ABSTRACT

A joint assembly for an agricultural implement includes a pin configured to pivotally couple an end of a wing frame to a main frame. The pin enables the wing frame to pivot about a longitudinal axis relative to the main frame. The joint assembly also includes a housing having a slot. The pin is disposed within the slot and configured to translate vertically within the slot to enable the wing frame to move vertically relative to the main frame.

### BACKGROUND

The present disclosure relates generally to a joint assembly for an agricultural implement.

Certain agricultural implements include ground engaging tools configured to interact with soil. For example, an agricultural implement may include tillage points and/or disc blades configured to break up the soil for subsequent planting or seeding operations. The agricultural implement may include a depth adjustment mechanism configured to control a penetration depth of the ground engaging tools into the soil. For example, the agricultural implement may include a depth control actuator configured to drive movement of a main frame or a wing frame relative to a set of wheels. However, during operation, height(s) of certain portion(s) of the main frame and/or the wing frame above the soil surface may be uneven due to variations in the soil surface. As a result, the penetration depth of ground engaging tools positioned at different locations on the main frame and/or the wing frame may vary. Therefore, the effectiveness of the tillage implement may be reduced.

### SUMMARY

In certain embodiments, a joint assembly for an agricultural implement includes a pin configured to pivotally couple an end of a wing frame to a main frame. The pin enables the wing frame to pivot about a longitudinal axis relative to the main frame. The joint assembly also includes a housing having a slot. The pin is disposed within the slot and configured to translate vertically within the slot to enable the wing frame to move vertically relative to the main frame.

### BRIEF DESCRIPTION OF THE DRAWINGS

These and other features, aspects, and advantages of the present disclosure will become better understood when the following detailed description is read with reference to the accompanying drawings in which like characters represent like parts throughout the drawings, wherein:

FIG. 1 is a perspective view of an embodiment of an agricultural implement having a main frame and two wing frames, in accordance with an aspect of the present disclosure;

FIG. 2 is a perspective view of a portion of the agricultural implement of FIG. 1, illustrating, in detail, an attachment of one of the wing frames to the main frame, in accordance with an aspect of the present disclosure;

FIG. 3 is a perspective view of a portion of the agricultural implement of FIG. 1, illustrating a difference in height between one of the wing frames and the main frame, in accordance with an aspect of the present disclosure.

FIG. 4 is a perspective view of an embodiment of a joint assembly that may be employed within the agricultural implement of FIG. 1, in accordance with an aspect of the present disclosure.

FIG. 5 is a schematic diagram of an embodiment of a control system that may be employed within the agricultural implement of FIG. 1, in accordance with an aspect of the present disclosure.

### DETAILED DESCRIPTION

One or more specific embodiments of the present disclosure will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” “the,” and “said” are intended to mean that there are one or more of the elements. The terms “comprising,” “including,” and “having” are intended to be inclusive and mean that there may be additional elements other than the listed elements. Any examples of operating parameters and/or environmental conditions are not exclusive of other parameters/conditions of the disclosed embodiments.

As briefly discussed above, an agricultural implement may be used to interact with soil in order to till, plow, or otherwise prepare the soil for agricultural usage. To enable interaction with the soil surface, the agricultural implement may include multiple ground engaging tools coupled to the main frame and/or to one or more wing frames. For example, the agricultural implement may be a tillage implement having tillage points and/or disc blades configured to break up the soil for seeding. In order to enable the agricultural implement to span a wide area, the structure of the agricultural implement may include multiple frames. The multiple frames may include one or more wing frames attached to a main frame, such that the one or more wing frames extend laterally outward from the main frame and thereby widen the reach of the ground engaging tools. In many applications, a wing frame may be configured to fold to transition the agricultural implement into a compact form for transport. For example, a folding actuator (e.g. hydraulic) may be coupled to the main frame and the wing frame, such that the actuator is configured to lift the wing frame up into a stowed position and/or push the wing frame down into a deployed position. To enable folding, the wing frame may be pivotally coupled to the main frame at a joint having a pin, such that the wing frame is configured to pivot about the pin.

The agricultural implement may include a depth control system to lower and raise the ground engaging tools relative to the soil. The depth control system may include lifting actuators (e.g. hydraulic cylinders) coupled to the wing frame and/or the main frame. Ordinarily, the wing frame and the main frame may be connected at the joint such that the joint constrains connecting ends of the wing frame and the main frame to be joined at a same vertical position. That is, vertical translation of the joint corresponds to a congruent vertical translation of corresponding ends of the wing frame and the main frame. In some situations, elevation of a soil surface may vary along a span of the agricultural implement. Because the wing frame and the main frame are constrained at the same vertical position, the penetration depth of the ground engaging tools may vary along the span of the agricultural implement. For example, wheels of the main frame may contact the soil surface at a first elevation, and wheels of the wing frame may contact the soil surface at a second elevation, different than the first elevation. Because the pin constrains the vertical position of the wing frame relative to the main frame, portions of the agricultural implement may tilt, thereby causing inconsistent penetration depth of the ground engaging tools, and/or elements of the agricultural implement may experience undesirable stress. In order to maintain a substantially consistent depth of the ground engaging tools, it may be desirable to adjust the height of the wing frame independently of the main frame and/or other wing frames. It may also be beneficial to adjust the height of the main frame independently of the wing frame. Moreover, it may be desirable to change the heights of the multiple frames while maintaining a substantially constant levelness of the frames with respect to the ground.

As described in further detail below, embodiments of the present disclosure include an agricultural implement having a joint assembly configured to enable motion of the wing frame with two degrees of freedom relative to the main frame. In a first degree of freedom, a first frame (e.g. wing frame) is pivotally coupled to a second frame (e.g. main frame) at a pin. In a second degree of freedom, the pin is configured to translate vertically within a housing, thereby enabling vertical displacement of one frame relative to the other frame. For example, the first frame and the second frame may be pivotally attached at a pin while the pin itself may move in a vertical direction. In this way, operation of the agricultural implement may be improved by enabling lifting actuators to control the height of the first frame and the second frame independently of each other without inducing a force nor moment on the other frame. Some embodiments described below and depicted in the drawings include the main frame coupled to a first wing frame on one side of the main frame and a second wing frame on the other side. However, other embodiments may include the main frame coupled to any number of wing frames, the wing frames coupled to any number of other wing frames, the coupling between the frames including any number of joint assemblies, and any number of lifting and locking actuators coupled to the main frame and the wing frame(s). For example, in some embodiments, the first wing frame may be attached to the main frame on one side at a first rear joint assembly and a first front joint assembly. The second wing frame may be attached to the main frame on the other side (opposite side) of the main frame at a second rear joint assembly and a second front joint assembly. Where the description below refers to singular components, such as “a wing frame” or “a lifting actuator”, the present disclosure is not particularly limited regarding the number of components, sections, or frames.

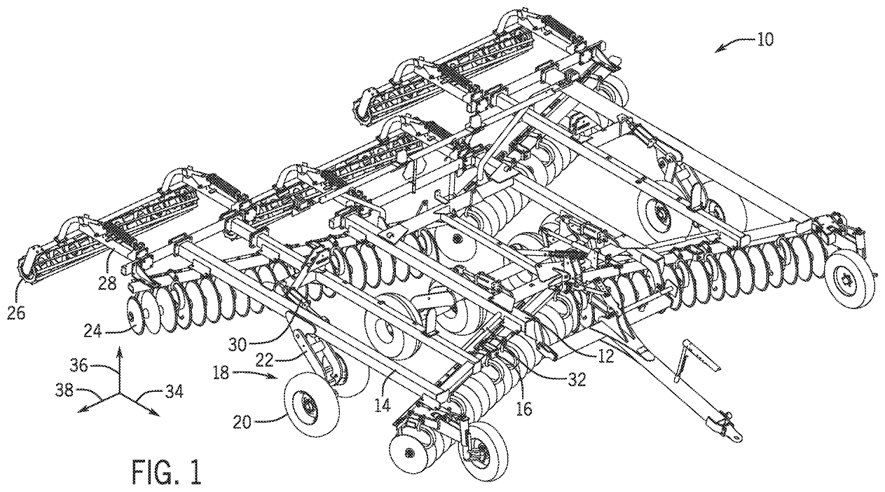

Turning now to the drawings, FIG. 1 is a perspective view of an embodiment of an agricultural implement 10 having a main frame 12 and two wing frames 14. Each wing frame 14 is coupled to the main frame 12 via a respective joint assembly 16. As shown, the agricultural implement 10 includes wheel assemblies 18 movably coupled to the agricultural implement. In the illustrated embodiment, each wheel assembly 18 includes a wheel 20 pivotally coupled to the wing frame 14 via a linkage arm 22. The wheel 20 is configured to engage the soil surface and support at least a portion of the weight of the agricultural implement 10. The linkage arm 22 is configured to pivot relative to the respective frame, thereby causing the wheel assembly 18 to lift or lower the respective frame. In some embodiments, each wheel assembly 18 may include two or more wheels 20, and one or more wheel assemblies may be coupled to each frame. For example, one wing frame may include a first wheel assembly at an inboard position (i.e., nearer to the center of the agricultural implement) and a second wheel assembly located at an outboard position.

In the illustrated embodiment, the agricultural implement 10 includes ground engaging tools, such as disc blades 24, finishing reels 26, and baskets. The disc blades 24 are configured to engage a top layer of the soil. As the agricultural implement 10 is towed through the field, the disc blades 24 are driven to rotate, thereby breaking up the top layer. In the illustrated embodiment, the disc blades 24 are arranged in two rows. However, in alternative embodiments, the disc blades may be arranged in more or fewer rows (e.g., 1, 3, 4, 5, 6, or more). In addition, the angle of each row relative to the direction of travel may be selected to control the interaction of the disc blades 24 with the top layer of soil. The agricultural implement may additionally or alternatively include tillage point assemblies configured to engage the soil at a greater depth, thereby breaking up a lower layer of the soil. The shape of each tillage point, the arrangement of the tillage point assemblies, and the number of tillage point assemblies may be selected to control tillage within the field.

In the illustrated embodiment, the finishing reels 26 are rotatably coupled to finishing reel frames 28, and the finishing reel frames 28 are pivotally coupled to respective frames of the agricultural implement (e.g., the main frame 12 and the wing frames 14). While each finishing reel frame is pivotally coupled to a respective frame in the illustrated embodiment, in other embodiments, the finishing reel frame 28 may be movably coupled to the respective frame by a linkage assembly (e.g., four bar linkage assembly, etc.) or another suitable assembly/mechanism that enables the finishing reel frame to move vertically relative to the respective frame. Furthermore, in certain embodiments, at least one finishing reel frame may be non-translatably and/or non-rotatably coupled to the respective frame, and/or at least one finishing reel frame may be omitted.

While the illustrated agricultural implement includes the disc blades 24 and the finishing reels 26, in other embodiments, the agricultural implement may include other and/or additional ground engaging tool(s). For example, the disc blades and/or the finishing reels may be omitted in certain embodiments. Furthermore, in certain embodiments, the agricultural implement may include one or more other suitable ground engaging tools, such as coulter(s), opener(s), finishing disc(s), and tine(s), among other suitable ground engaging tools. Furthermore, while the agricultural implement 10 is a vertical tillage implement in the illustrated embodiment, in other embodiments, the agricultural implement may be a primary tillage implement, another suitable type of tillage implement, a seeding implement, a planting implement, or another suitable type of implement. Furthermore, while the agricultural implement includes two wing frames 14 in the illustrated embodiment, in other embodiments, the agricultural implement may include more or fewer wing frames (e.g., 1, 3, 4, or more).

In order to adjust the depth of the ground engaging tools, lifting actuators 30 (e.g. hydraulic cylinders, electrohydraulic actuators) may raise or lower respective frames (e.g., wing frames 14, main frame 12) of the agricultural implement 10. Each lifting actuator 30 may be coupled to the linkage arm 22 of the respective wheel assembly 18. While each lifting actuator 30 includes a single hydraulic cylinder in the illustrated embodiment, in other embodiments, at least one lifting actuator 30 may include multiple hydraulic cylinders (e.g., 2, 3, 4, 5, 6, etc.). Furthermore, in certain embodiments, at least one lifting actuator may include any other suitable type(s) of actuator(s) (e.g., hydraulic motor(s), pneumatic cylinder(s), pneumatic motor(s), electromechanical actuator(s), linear actuator(s), screw drive(s), etc.). In embodiments in which the actuator(s) are controlled by fluid (e.g., air, hydraulic fluid, etc.), the actuator(s) may be controlled via appropriate valve assembly/assemblies.

In order to fold each wing frame into a stowed position for transport, a folding actuator 32 may be coupled to each wing frame such that actuation of the folding actuator 32 causes the wing frame to pivot about a longitudinal axis 34 at the joint assembly 16. That is, the folding actuator 32 may change an angle of one frame relative to another frame. Accordingly, each joint assembly 16 includes a pin configured to enable pivoting of one frame relative to an end of another frame. While each folding actuator 32 has a single hydraulic cylinder in the illustrated embodiment, in other embodiments, at least one folding actuator may include multiple hydraulic cylinders (e.g., 2, 3, 4, 5, 6, etc.). Furthermore, in certain embodiments, at least one folding actuator may include any other suitable type(s) of actuator(s) (e.g., hydraulic motor(s), pneumatic cylinder(s), pneumatic motor(s), electromechanical actuator(s), linear actuator(s), screw drive(s), etc.). In embodiments in which the actuator(s) are controlled by fluid (e.g., air, hydraulic fluid, etc.), the actuator(s) may be controlled via appropriate valve assembly/assemblies.

As discussed above, it may be desirable to adjust the vertical position (e.g., along a vertical axis 36) of each wing frame 14 independently of the height of the main frame 12 and vice versa. For example, the elevation of a soil surface may vary across the span of the agricultural implement 10 (e.g., at different points along a lateral axis 38). It is now observed that an ability to lift one frame (e.g., the wing frame 14) independently of one or more other frames (e.g., the main frame 12) may improve the agricultural operation by conforming the frames to the same height above the respective soil surface.

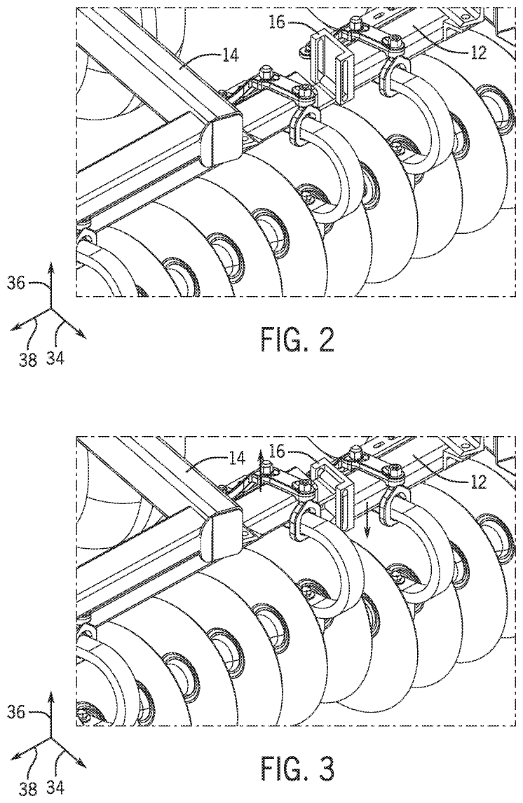

FIG. 2 is a perspective view of a portion of the agricultural implement of FIG. 1, illustrating, in detail, a coupling between the main frame 12 and a wing frame 14. As shown, the wing frame 14 forms a linkage connection with the main frame 12 when the agricultural implement is unfolded in a deployed configuration. In situations in which the soil surface is level, the main frame 12 and the wing frame 14 may lie along the same horizontal plane, and their respective ground engaging tools 20 may penetrate the soil to the same depth. In other cases, the wing frame 14 may be at a different height above the soil surface than the main frame 12. Then, the joint assembly 16 enables the wing frame 14 to move vertically relative to the main frame 12, thereby enabling each frame to effectively maintain the penetration depth of respective ground engaging tools as the elevation of the soil surface varies along the width of the agricultural implement. That is, the joint assembly 16 enables translational adjustment between the connecting ends of the wing frame 14 and the main frame 12. Moreover, the joint assembly 16 enables the wing frame 14 to fold into a stowed or deployed position, as discussed above.

FIG. 3 is a perspective view of a portion of the agricultural implement 10 of FIG. 1, in which the wing frame 14 and the main frame 12 are disposed at different heights corresponding to different soil elevations. In accordance with the present disclosure, the joint assembly 16 enables a connecting end of the wing frame 14 to be situated above the connecting end of the main frame 12. A height difference between the connecting ends of the wing frame 14 and the main frame 12 may be adjustable or configurable in real-time via the lifting actuators 30. Hence, the joint assembly 16 enables the wing frame 14 to operate at a different vertical position than the main frame 12 (e.g., while keeping both frames substantially parallel to the ground).

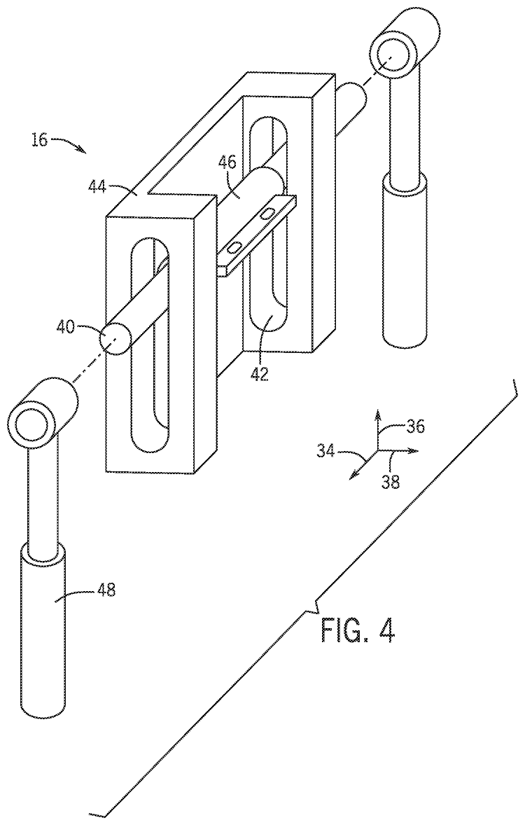

FIG. 4 is a perspective view of an embodiment of a joint assembly 16 that may be employed within the agricultural implement of FIG. 1. In the illustrated embodiment, the joint assembly 16 includes a pin 40 configured to translate (e.g. slide) along a slot 42 in a housing 44. A length of the slot 42 extends along the vertical axis 36. The housing 44 may be part of the wing frame 14 or the main frame 12. In another embodiment, the housing 44 may be configured to couple to one of the wing frame 14 or the main frame 12. The pin 40 may be configured to couple to the other of the wing frame 14 or the main frame 12. In some embodiments, a collar 46 around the pin 40 may be attached to, the wing frame 14 or the main frame 12. The collar 46 may be free to swivel freely about the pin 40 (e.g. via ball bearings), or the collar 46 may be pivotally fixed relative to the pin 40. In other embodiments, the pin 40 may be coupled to a frame as part of a clevis, a shackle, or another suitable linkage component. In any case, the wing frame 14 and the main frame 12 may be free to pivot relative to one another to facilitate folding as discussed above. At the same time, the housing 44 constrains movement of the pin 40 along the lateral axis 38, causing the positions of the frames to remain fixed along the lateral axis 38. In this way, the pin 40 being free to translate along the slot 42 may reduce or eliminate a reaction force at the joint assembly 16 caused by the lifting actuator. Therefore, tilting of the frames relative to the ground may be reduced.

In certain embodiments, the joint assembly 16 includes a locking actuator 48 configured to mitigate unwanted vertical motion of the joint-facing ends of the frames. For example, if the pin 40 were free to slide up and down within the slot 42, the wing frame 14 may tend to excessively bounce or wobble over uneven terrain. Moreover, the wing frame 14 and the main frame 12 may tilt or bind with respect to one another without a supporting force at the joint assembly 16. Therefore, it may be desirable to controllably lock and unlock the position of the pin 40 in the slot 42. That is, the locking actuator 48 may be configured to unlock the position of the pin 40 during actuation of the lifting actuator(s) and to lock the position of the pin 40 otherwise. In some embodiments, the locking actuator 48 may be configured to lock the pin 40 at one of multiple positions. In other embodiments, the locking actuator 48 may lock the pin 40 at any position within a continuous range. Likewise, the lifting actuator may be configured to lift the wing frame to one of multiple positions or to lift the wing frame to any position along a continuous range. Furthermore, the locking actuator 48 may help to level the wing frame by providing a support point to balance a moment produced by the weight of the wing frame about the wheel assembly/assemblies. For example, as a lifting actuator produces a lifting or supporting force at one point of the wing frame, the locking actuator 48 may provide support at another point of the wing frame to substantially reduce or eliminate tilting. In the illustrated embodiment, the locking actuator 48 (e.g., hydraulic cylinder, electrohydraulic actuator, jackscrew) is coupled to the pin 40 in order to fix the vertical position of the pin 40 within the slot 42. The locking actuator 48 may be rigidly or pivotally coupled to the pin 40. In other embodiments, the locking actuator 48 may be rigidly or pivotally coupled to the collar 46. Furthermore, the locking actuator 48 may be rigidly or pivotally coupled to the housing 44 or the frame to which the housing 44 is attached. In certain embodiments, the locking actuator 48 may be configured to drive the pin 40 into and out of a selected aperture of a set of apertures, such that the selected aperture acts as a mechanical stop to lock the position of the pin 40 in the slot 42.

While the pin 40 moves through two slots in the illustrated embodiment, in other embodiments, the pin may move through more or fewer slots. Furthermore, while the slots are linear in the illustrated embodiment, in other embodiments, the slots may have other suitable shapes (e.g., curved, etc.).

The locking actuator 48 may be hydraulically controlled via a valve. The valve may be configured to regulate a fluid path between the locking actuator and a hydraulic fluid source (e.g., including a tank and a pump). For example, the valve may be configured to open or close in response to a signal to lock or unlock the position of the locking actuator. Each locking actuator 48 may be part of a hydraulic circuit that includes the lifting actuators and/or other hydraulic actuator(s) of the agricultural implement. The hydraulic circuit may be communicatively coupled to a control system disposed on the agricultural implement or on a work vehicle coupled to the agricultural implement.

In one embodiment, the locking actuator 48 may be free to move (e.g., extend or retract) while the lifting actuator(s) adjust the vertical position(s) of the frame(s). When lifting is complete, the locking actuator 48 may actuate to lock the vertical position(s) until further adjustment is needed. That is, the locking actuator 48 provides a locking force to set and maintain the vertical position after the lifting is complete.

In another embodiment, the locking actuator 48 may supply a lifting force to drive the pin to move to a desired location. That is, the lifting actuator(s) may produce a lifting force on the frame at a first location (e.g., the wheel assembly 18 at a distal end of the frame) while the locking actuator 48 provides another lifting force on the frame at a second location (e.g., the joint assembly 16). In this way, a force produced by the lifting actuator at the first location may be balanced by another force produced by the locking actuator at the second location.

In some embodiments, the folding actuator may perform a locking and/or lifting function for the wing frame. For example, the folding actuator may lock and unlock a position of the wing frame during a lifting operation, such that the folding actuator may controllably constrain movement of the pin 40 along the slot 42. In this way, the folding actuator may be considered the locking actuator 48.

In certain embodiments, an inboard wheel assembly and an outboard wheel assembly may be coupled to a wing frame. In such embodiments, one lifting actuator may be coupled to the inboard wheel assembly, and another lifting actuator may be coupled to the outboard wheel assembly. That is, in embodiments in which two wheel assemblies are coupled to the wing frame, one of the wheel assemblies may perform a lifting function via a first lifting actuator (e.g., lifting actuator), and the other wheel assembly may perform a lifting function via a second lifting actuator (e.g., lifting actuator). That is, the first and/or second lifting actuators may include an internal locking mechanism (e.g. a valve) in lieu of a dedicated locking actuator. Accordingly, the locking actuator may be omitted because the orientation of the wing frame is controlled at two points.

While the locking actuator 48 includes two hydraulic cylinders in the illustrated embodiment, in other embodiments, the locking actuator 48 may include any number of hydraulic cylinders (e.g., 1, 3, 4, 5, 6, etc.). Furthermore, in certain embodiments, the locking actuator 48 may include any other suitable type(s) of actuator(s) (e.g., hydraulic motor(s), pneumatic cylinder(s), pneumatic motor(s), electromechanical actuator(s), linear actuator(s), screw drive(s), etc.). In embodiments in which the actuator(s) are controlled by fluid (e.g., air, hydraulic fluid, etc.), the locking actuator 48 may be controlled via an appropriate valve assembly.

In certain embodiments, the locking actuator 48 may be omitted. That is, the vertical positions of the frames may be controlled by the lifting actuators 30 without dedicated locking mechanisms of the locking actuator 48. The lifting actuators 30 may have internal locking mechanisms to set and maintain a desired position.

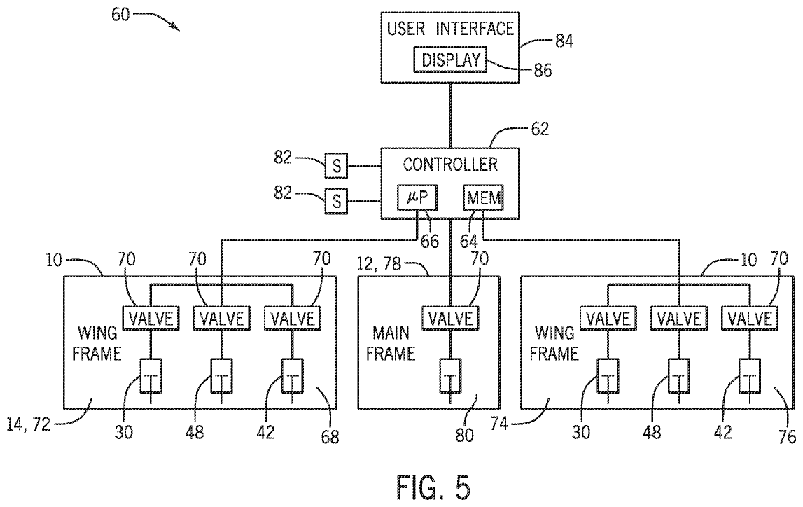

FIG. 5 is a schematic diagram of an embodiment of a control system 60 that may be employed within the agricultural implement of FIG. 1. In the illustrated embodiment, the control system 60 includes a controller 62 having a memory device 64 and processing circuitry 66 (e.g. microprocessor). The controller 62 may also include one or more storage devices and/or other suitable components. The processing circuitry 66 may be used to execute software, such as software for controlling one or more actuators (e.g., lifting actuator(s) 30, locking actuator(s) 48, folding actuator(s) 32). Moreover, the processing circuitry 66 may include multiple microprocessors, one or more “general-purpose” microprocessors, one or more special-purpose microprocessors, and/or one or more application specific integrated circuits (ASICS), or some combination thereof. For example, the processing circuitry 66 may include one or more reduced instruction set (RISC) processors.

The memory device 64 may include a volatile memory, such as random access memory (RAM), and/or a nonvolatile memory, such as read-only memory (ROM). The memory device 64 may store a variety of information and may be used for various purposes. For example, the memory device 64 may store processor-executable instructions (e.g., firmware or software) for the processing circuitry 66 to execute, such as instructions for controlling the actuator(s). The storage device(s) (e.g., nonvolatile storage) may include ROM, flash memory, a hard drive, or any other suitable optical, magnetic, or solid-state storage medium, or a combination thereof. The storage device(s) may store data, instructions (e.g., software or firmware for controlling the actuator(s), etc.), and any other suitable data.

In the illustrated embodiment, the controller 62 is an element of the control system 60 and may be located in/on the agricultural implement 10. However, in other embodiments, the controller may be located in/on a work vehicle coupled to the agricultural implement 10. Furthermore, in certain embodiments, one or more functions of the controller 62 may be distributed across multiple control devices (e.g., the control devices forming the controller 62).

In the illustrated embodiment, the controller 62 is communicatively coupled to a first set of actuators 68 at a first frame 72. In the illustrated embodiment, the first frame 72 corresponds to one wing frame 14. In other embodiments, the first frame 72 may correspond to the main frame 12. The first set of actuators 68 may include one or more lifting actuators, one or more locking actuators, one or more folding actuators, or a combination thereof. For example, in certain embodiments, the first set of actuators 68 includes the lifting actuator(s) 30, the locking actuator(s) 48, and the folding actuator(s) 32. In embodiments in which at least one actuator is an electric actuator (e.g., linear actuator, electric motor, etc.), the controller 62 may be communicatively coupled directly to the actuator(s). In the illustrated embodiment, the actuators 30, 32, 48 are fluid actuators (e.g., hydraulic actuator(s), pneumatic actuator(s)), and the controller 62 is communicatively coupled to the actuators 30, 32, 48 via respective valve assemblies 70. The valve assemblies 70 are fluidly coupled to the actuators, such that the valve assemblies 70 control a flow of a fluid (e.g. hydraulic fluid, air) to the actuators 30, 32, 48 (e.g. from fluid source(s), via flow path(s)). Each of the valve assemblies 70 may include any suitable number and/or type(s) of valve(s) (e.g., proportional control valve(s), gate valve(s), check valve(s), needle valve(s), etc.) and other suitable component(s) (e.g., hose(s), fluid passage(s), solenoid(s), etc.) to control the flow of fluid to the respective actuator (e.g., from a fluid source) and, in certain embodiments, from the respective actuator (e.g., to a fluid tank, etc.). The valve assemblies 70 may be located on the agricultural implement 10, the work vehicle towing the agricultural implement 10, or a combination thereof.

In the illustrated embodiment, the controller 62 is communicatively coupled to a second set of actuators 76 at a second frame 74. In the illustrated embodiment, the second frame 74 corresponds to another wing frame, similar to the first wing frame 14. In other embodiments, the second frame 74 may correspond to the main frame 12, if the first frame 72 does not correspond to the main frame 12. Like the first set of actuators 68, the second set of actuators 76 may include one or more lifting actuators, one or more locking actuators, one or more folding actuators, or a combination thereof. In embodiments in which at least one actuator is an electric actuator (e.g., linear actuator, electric motor, etc.), the controller may be communicatively coupled directly to the actuator(s) of the second set of actuators 76. In the illustrated embodiment, the actuators are fluid actuators (e.g., hydraulic actuator(s), pneumatic actuator(s)), and the controller 62 is communicatively coupled to the actuators of the second set of actuators 76 via the respective valve assemblies 70.

Additionally, in the illustrated embodiment, the controller 62 is communicatively coupled to a third set of actuator(s) 80 at a third frame 78. In the illustrated embodiment, the third frame 78 corresponds to the main frame 12. In other embodiments, the third frame 78 may correspond to another wing frame, like the first wing frame 14. The third set of actuator(s) 80 may include one or more lifting actuators, one or more locking actuators, one or more folding actuators, or a combination thereof. In embodiments in which at least one actuator is an electric actuator (e.g., linear actuator, electric motor, etc.), the controller may be communicatively coupled directly to the actuator(s) of the third set of actuator(s) 80. In the illustrated embodiment, the actuator(s) are fluid actuator(s) (e.g., hydraulic actuator(s), pneumatic actuator(s)), and the controller 62 is communicatively coupled to the actuator(s) of the third set of actuator(s) 80 via the respective valve assembly/assemblies 70.

While the controller 62 controls actuators at the wing frame 14, the additional wing frame, and the main frame 12 in the illustrated embodiment, in other embodiments, the controller may control any number of set(s) of actuator(s) in any number of wing frame(s). Additionally, in certain embodiments, the controller may not control the height of the main frame and/or one or more wing frames. In any case, the controller may control the first, second, and third sets of actuator(s) independently of each other. For example, the controller may control the first, second, and third sets of actuator(s) in a coordinated manner as to substantially maintain levelness and uniform penetration depth across the agricultural implement 10.

In the illustrated embodiment, the controller 62 is communicatively coupled to one or more sensors 82 configured to detect position(s) (e.g. height(s)) of one or more frames. For example, one of the sensors 82 may be a first sensor coupled to the first frame 72 and configured to output a sensor signal indicative of a first height of the first frame 72. Another sensor 82 may be a second sensor coupled to the second frame 74 or the third frame 78 and configured to output a sensor signal indicative of a second height of the second frame 74 or the third frame 78. The sensors may include ultrasound sensor(s), radar (e.g. millimeter wave (MMW)) sensor(s), lidar (e.g. time-of-flight scanning) sensor(s), capacitive sensor(s), other suitable type(s) of sensor(s), or a combination thereof. Furthermore, at least one sensor may be a contact sensor (e.g. including a ground contact element) configured to monitor the height of the respective frame above the soil surface.

The controller 62 may receive the sensor signal(s) output by the sensor(s) 82 and perform certain actions based on feedback from the sensor(s). For example, the controller 62 may compare the first height and the second height to determine whether a difference in height between two or more frames (e.g., the main frame 12 and the wing frame 14) is less than a threshold value (e.g. 1 mm, 3 mm, 10 mm, 15 mm, etc.). In response to determining that the first height and the second height are significantly different (e.g., the height difference is greater than the threshold value), the controller 62 may control one or more lifting actuators 30 and/or one or more locking actuators 48 to substantially equalize the heights of the frames. As discussed above, the locking actuator 48 may be free to move until the lifting actuator(s) 30 finish lifting a respective frame to a desired height. Then, the locking actuator 48 may lock the vertical position of the respective frame. In certain embodiments, the locking actuator 48 may drive the pin to move to a desired location in coordination with the lifting actuator(s) 30. The controller 62 may perform height adjustments automatically using an automatic feedback control system (e.g. using a PID control method).

In certain embodiments, the control system 60 may include sensors 82 to measure at least two heights of a single frame (e.g., the first frame 72) in at least two locations (e.g., an inboard location and an outboard location). The controller 62 may control the lifting actuator(s) 30 and the locking actuator(s) 48 of one or more frames, such that the respective frame(s) are substantially level along the lateral axis 38 of the agricultural implement. For example, the controller 62 may control the lifting actuator(s) 30 and the locking actuator(s) 48 such that a difference between the two heights is within a threshold value. Accordingly, an agricultural system may achieve more consistent penetration depth of the ground engaging tools.

In the illustrated embodiment, the controller 62 is communicatively coupled to a user interface 84. The user interface 84 may receive input, such as instructions or requests for information, from an operator. Additionally, the user interface 84 includes an electronic display device 86 configured to display system information and/or input prompts. The electronic display device 86 may include an LCD or LED display, and the electronic display device 86 may include touchscreen functionality to receive user input. Via the user interface, the operator may configure and adjust the heights of the wing frame(s) and/or the main frame. Additionally, the user interface may present monitored heights of the frames to the operator.

While only certain features have been illustrated and described herein, many modifications and changes will occur to those skilled in the art. It is, therefore, to be understood that the appended claims are intended to cover all such modifications and changes as fall within the true spirit of the disclosure.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for (perform)ing (a function) . . . ” or “step for (perform)ing (a function) . . . ”, it is intended that such elements are to be interpreted under 35 U.S.C. 112(f). However, for any claims containing elements designated in any other manner, it is intended that such elements are not to be interpreted under 35 U.S.C. 112(f).

1. A joint assembly for an agricultural implement comprising:
a pin configured to pivotally couple an end of a wing frame to a main frame, wherein the pin enables the wing frame to pivot about a longitudinal axis relative to the main frame; and
a housing comprising a slot, wherein the pin is disposed within the slot and configured to translate vertically within the slot to enable the wing frame to move vertically relative to the main frame.

2. The joint assembly of claim 1, wherein the housing is configured to couple to one of the main frame or the wing frame.

3. The joint assembly of claim 2, comprising a collar disposed around the pin, wherein the collar is configured to couple to the other of the main frame or the wing frame.

4. The joint assembly of claim 3, comprising a bearing disposed between the pin and the collar, wherein the bearing is configured to enable the collar to swivel about the pin.

5. The joint assembly of claim 1, comprising a locking actuator configured to control a position of the pin within the slot.

6. An agricultural system comprising:
a main frame configured to support a first plurality of ground engaging tools;
a wing frame configured to support a second plurality of ground engaging tools;
a joint assembly coupling the wing frame to the main frame, comprising:
a pin coupled to one of the main frame or the wing frame;
a housing coupled to or integrally formed with the other of the main frame or the wing frame, wherein the housing comprises a slot, and the pin is disposed within the slot and configured to translate vertically within the slot to enable the wing frame to move vertically relative to the main frame.

7. The agricultural system of claim 6, comprising a locking actuator coupled to the pin and configured to control a position of the pin within the slot.

8. The agricultural system of claim 6, comprising a locking actuator configured to couple to a wheel assembly of the wing frame, wherein the locking actuator is configured to control a position of the pin within the slot.

9. The agricultural system of claim 6, comprising a lifting actuator configured to couple to a wheel assembly of the wing frame.

10. The agricultural system of claim 9, wherein the lifting actuator is configured to adjust a height of the wing frame relative to a ground surface.

11. The agricultural system of claim 6, comprising:
a second wing frame configured to support a third plurality of ground engaging tools;
a second joint assembly coupling a second wing frame to the main frame, comprising:
a second pin, coupled to one of the main frame or the second wing frame; and
a second housing, coupled to the other of the main frame or the second wing frame, comprising a second slot, wherein the second pin is disposed within the second slot and configured to translate vertically within the slot;
a second lifting actuator coupled to a wheel of the second wing frame, wherein the second lifting actuator is configured to adjust a height of the second wing frame relative to the ground.

12. The agricultural system of claim 11, comprising a second locking actuator coupled to the second pin and configured to control a second position of the second pin within the second slot.

13. The agricultural system of claim 6, comprising:
a second joint assembly coupling the wing frame to the main frame, comprising:
a second pin coupled to one of the main frame or the wing frame;
a second housing, coupled to the other of the main frame or the wing frame, comprising a second slot, wherein the second pin is disposed within the second slot and configured to translate vertically within the second slot;

14. The agricultural system of claim 13, comprising a second locking actuator coupled to the second pin and configured to control a second position of the second pin within the second slot.

15. A control system for an agricultural implement, comprising:
a lifting actuator configured to adjust a height of a wing frame relative to a main frame;
a locking actuator configured to control a position of a pin disposed within a slot of a housing, wherein the pin configured to pivotally couple an end of the wing frame to the main frame, the pin enables the wing frame to pivot about a longitudinal axis relative to the main frame, and the pin is configured to translate vertically within the slot to enable the wing frame to move vertically relative to the main frame; and
a controller comprising a memory and processing circuitry, wherein the controller is configured to control the lifting actuator and the locking actuator.

16. The control system of claim 15, comprising a folding actuator configured to adjust an elevation angle of the wing frame relative to the main frame.

17. The control system of claim 15, comprising:
a first sensor communicatively coupled to the controller, wherein the first sensor is configured to output a first sensor signal indicative of a height of the main frame above a ground surface; and
a second sensor communicatively coupled to the controller, wherein the second sensor is configured to output a second sensor signal indicative of a height of the wing frame above the ground surface.

18. The control system of claim 17, wherein the controller is configured to control the lifting actuator and the locking actuator such that a difference between the height of the main frame above the ground surface and the height of the wing frame above the ground surface is less than a threshold value.

19. The control system of claim 15, comprising:
a first valve assembly configured to control a flow of fluid to the lifting actuator, wherein the controller is communicatively coupled to the lifting actuator via the first valve assembly; and
a second valve assembly configured to control a flow of fluid to the locking actuator, wherein the controller is communicatively coupled to the locking actuator via the second valve assembly.

20. The control system of claim 15, comprising:
a second lifting actuator configured to adjust a height of a second wing frame relative to a main frame or the first wing frame;
a second locking actuator configured to control a second position of a second pin disposed within a second slot of a second housing, wherein the second pin configured to pivotally couple an end of the second wing frame to the main frame, the second pin enables the second wing frame to pivot about a longitudinal axis relative to the main frame, and the second pin is configured to translate vertically within the second slot to enable the second wing frame to move vertically relative to the main frame.
